(19) United States
(12) Patent Application Publication
(10) Pub. No.: US 2008/0061957 A1
(43) Pub. Date: Mar. 13, 2008

(54) Doorbell presence hardware

(75) Inventors: Hong Thi Nguyen, Atlanta, GA (US); Michael Sean Denny, Sharpsburg, GA (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/520,131

(22) Filed: Sep. 13, 2006

(51) Int. Cl. G08B 23/00

(52) U.S. Cl. 340/501

(57) ABSTRACT

A doorbell presence hardware is configured to provide notification about a trigger event at an entry point such as a person at the door pressing a button. The doorbell presence hardware is equipped with physical components such as a camera, a microphone, a speaker, and the like, and associated client applications to facilitate user selected actions in response to the notification. The doorbell presence service controlling the doorbell presence hardware includes an integrated presence service to determine a location of the user and provide notification and a list of actions through a watcher client application. The interactions of the system are facilitated through network sessions.

### RELATED APPLICATIONS

The present application may be found to be related to U.S. patent application entitled: “MONITORING AND ENTRY SYSTEM PRESENCE SERVICE”, Ser. No. ______, filed with the USPTO on the same day as this patent application, Attorney Docket Number 60027.527US01/BS060216.

### TECHNICAL FIELD

Embodiments are related to presence services. More particularly, the disclosed subject matter is related to computer-implemented methods, configurations, systems, and devices for facilitating integration of door entry systems with a presence service.

### BACKGROUND

With the proliferation and improvement of network communications and the Internet, security monitoring applications have begun to take advantage of networking capabilities. Many applications are available today, which allow users to access their monitoring system remotely through the Internet and perform actions such as configuring the system, receiving status updates, and the like.

Intelligent devices are increasingly popular in modern society. In addition, these devices whether cell phones, computers, or motion detectors are usually connected to a network such as the Internet. In this interconnected environment, the trend is to provide presence awareness information about almost anyone to almost anyone. “Buddy List” applications, which enable people to communicate and/or forward their incoming communications to their designees, are becoming common in cellular phone and instant messaging systems. For example, some cellular phone companies provide a service, where a calling party can be forwarded to the called person at any number. All the called person has to do, is provide a list of numbers where they can be reached. The system automatically searches for the called person until he or she is found and facilitates the connection.

### SUMMARY

Consistent with embodiments described herein, systems and methods are disclosed for providing a notification and interaction system associated with a doorbell integrated with a unified presence application interface. Key features or essential features of the claimed subject matter are not necessarily identified in this summary portion.

Embodiments are directed to a doorbell presence service hardware and associated computer programs and methods that provide notification to a user in response to a trigger event at the doorbell. The doorbell service may include an integrated unified presence system, which allows the user to be notified through one of a plurality of means. The user may be provided a selection of actions in response to the notification including, but not limited to, two-way communication, enabling entry to a premise, obtaining a video or image of a location of interest, and the like. The doorbell hardware may include a number of integrated components and client applications that facilitate the user selected action(s).

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

FIG. 1 is a diagram of a monitoring and entry system presence service architecture;

FIG. 2 illustrates an example doorbell presence service architecture integrated with IMS infrastructure, where example embodiments may be implemented;

FIG. 3 illustrates a conceptual diagram of components of an example doorbell presence service;

FIG. 4 illustrates action flows in the example doorbell presence service of FIG. 2;

FIG. 5 illustrates action flows in the example doorbell presence service of FIG. 2 based on various watcher selection scenarios;

FIG. 6 illustrates an example doorbell presence service hardware according to embodiments;

FIG. 7 illustrates an example doorbell presence application UI; and

FIG. 8 illustrates a logic flow diagram for a process of providing doorbell presence service according to one embodiment.

### DETAILED DESCRIPTION

As briefly described above, a doorbell notification and interaction service may be provided with an integrated unified presence service. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

Referring now to the drawings, aspects, exemplary operating environments, and configurations will be described. While the embodiments will be described in the general context of program modules that execute in conjunction with an application program that runs on an operating system on a personal computer, those skilled in the art will recognize that aspects may also be implemented in combination with other program modules.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

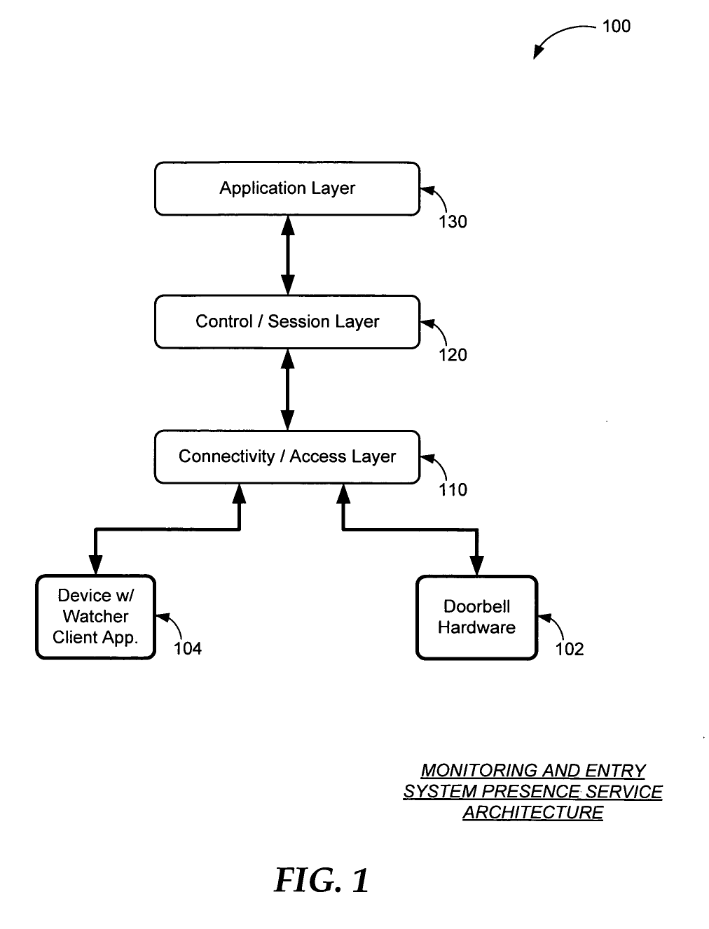

With reference to FIG. 1, a diagram of a monitoring and entry system presence service architecture is shown. Architecture 100 includes at a base level two kinds of physical devices: interface device 102 and device with watcher client application 104. Interface device is typically a component of a monitoring or entry system configured to provide the triggering event(s). According to one embodiment, interface device 102 may include a doorbell device integrated with additional functionality. Device with watcher client application 104 is used to provide the user with notification of the trigger event, present a selection of actions, and forward the user's selection to an application for execution of tasks associated with the selected action. In other embodiments, the user may be notified through one device and select actions to be performed through another device.

Connectivity and access layer 110 includes network infrastructure that is used to provide interconnection between devices 102, 104 and applications at higher levels. Connectivity layer may include any network or combination of networks. These network(s) may include a secure network such as a home network or an enterprise network, or an unsecure network such as a wireless open network. The networks provide communication between the nodes described above. By way of example, and not limitation, the networks may include wired media such as a wired network or direct-wired connection, and wireless media such as acoustic, RF, infrared and other wireless media.

Control and session layer 120 is arranged to facilitate communication sessions between the physical devices and the applications, as well as between the applications and any network resources such as data stores. According to some embodiments, the control and session layer may be integrated with an IP Multimedia System (IMS) for providing a unified presence service.

Application layer 130 includes one or more applications associated with providing a notification and interaction service with an integrated unified presence service. Application layer 130 may include an application arranged to perform actions associated with the devices 102 and 104, an application for providing the presence service, and even an application for providing a location service to determine a location of a user to be notified.

Interface device 102 and device with watcher client application 104 may include or may be part of a computing device. Computing devices typically include a processing device and a system memory. Computing devices may also include additional processing devices, which may be dedicated processors or enable distributed processing by coordinating with a main processing device. The system memory may be volatile (such as RAM), non-volatile (such as ROM, flash memory, etc.) or some combination of the two. System memory typically provides an environment for an operating system to be executed for controlling the operation of computing device 100 and execution of other programs (applications). Watcher client application, two-way communication applications, imaging or video communication applications are examples of programs or program modules that may be executed in the system memory. These applications may be an integrated part of a single program or separate applications. They may communicate with other applications running on the computing device or on other devices.

The computing devices may have additional features or functionality. For example, the computing devices may also include data storage devices (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. The system memory and storage devices are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. Any such computer storage media may be part of the computing device.

Computing devices may also include input devices such as a keyboard, a keypad, a voice input device, a touch input device, a camera etc. Furthermore, output devices such as a display, a speaker, a printer, etc. may also be included. These devices are well known in the art.

Communication connections may be included in the computing devices to allow the device to communicate with other computing devices executing above described applications, such as over a network in a distributed computing environment, for example, an intranet or the Internet. Communication connections may include media that may be embodied by computer readable instructions, data structures, program modules, or other data in a modulated data signal, such as a carrier wave or other transport mechanism, and include any information delivery media.

By way of example, and not limitation, communication media may include wired media such as a wired network or direct-wired connection, and wireless media such as acoustic, RF, infrared and other wireless media. The term computer readable media as used herein refers to both storage media and communication media. Communication media is employed to provide interconnection between interface device 102, device with watcher client application 104 and networks of connectivity and access layer 110.

The implementation of embodiments for interface device 102 and device with watcher client application 104 is not limited to the computing devices described above. Other computing devices with different components, configurations, and the like, may be used to execute computer readable instructions implementing embodiments described herein without departing from a scope and spirit of the claimed subject matter.

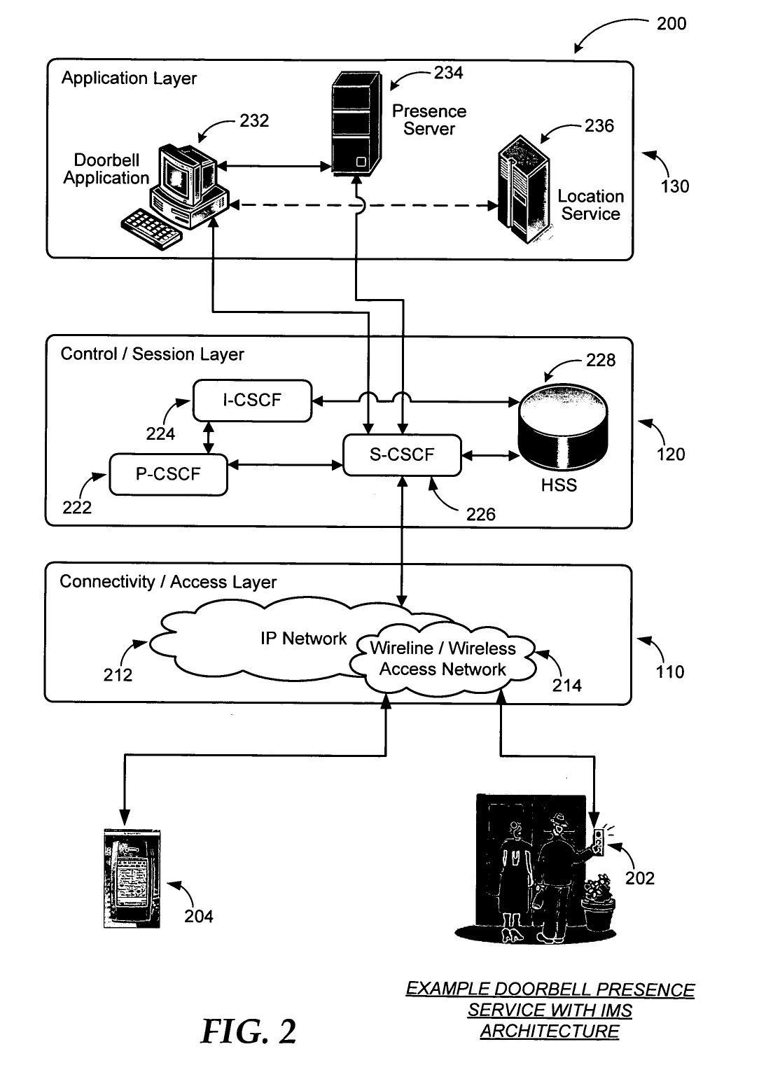

FIG. 2 and the following discussion are intended to provide a brief, general description of a suitable computing environment in which the invention may be implemented. Referring to FIG. 2, an example doorbell presence service architecture with integrated IMS infrastructure, where example embodiments may be implemented, is illustrated. Architecture 200 may include at various layers any topology of servers, clients, Internet service providers, and communication media. Applications such as doorbell application 232 and location service 236 may be one or more programs or a server machine executing programs associated with the server tasks. Client devices and servers may be embodied as single device (or program) or a number of devices (programs). Similarly, data sources may include one or more data stores, input devices, and the like.

Interface device 102 and device with watcher client application 104 of FIG. 1 are exemplified in FIG. 2 as doorbell 202 with additional functionality and handheld computing device 204, such as a smartphone, a PDA, and the like. In response to the doorbell being rung, a notification is sent by the doorbell 202 to other network 214 of connectivity and access layer 110. Connectivity and access layer 110 may include one or more networks. For example, a wired or wireless access network may be employed to establish communication with the doorbell and an IP network may be utilized to facilitate communication with computing device 204. The IP network may further be used to facilitate communications between the various applications of application layer 130. As mentioned previously, the networks of the connectivity and access layer may include secure, open, wired, wireless networks of any type including the Internet.

Control and session layer 120 manages communication sessions between the physical devices, client applications executed on the physical devices and the applications of the application layer 130. In architecture 200, control and session layer 120 is based on IMS infrastructure. An IMS control and session layer includes a number of functions and a data store service. IMS is an open-systems architecture that supports a range of IP-based services over both packet switch and circuit switch networks, employing both wireless and fixed access technologies.

P-CSCF 222 is proxy call state control function, which is typically a first point of contact. It may provide privacy control, quality of service (QoS), authorization of local services, and similar functionalities. P-CSCF 222 interacts through SIP with I-CSCF 224 (interrogating call state control function), which may provide an access point functionality to the network and enable protection of a topology and configuration of the network. I-CSCF 224 interacts through SIP with S-CSCF 226 (serving call state control function), which provide session control services such as registration, accounting, and the like. Both I-CSCF 224 and S-CSCF 226 interact with HSS 228 (home subscriber service), which is essentially a data store service for storing presence information (e.g. where the user can be reached). HSS 228 may be embodied as one or more data stores that may be managed by a data server.

Applications layer 130 includes doorbell application 232, presence server 234, and optional location service 236. As mentioned above, these applications may be executed on a single machine or on separate machines. Doorbell application 232 is configured to receive notification from doorbell 202, communicate with presence server 234 and optional location service 236 to determine a location and reach the user through computing device 204, and perform tasks for execution of action(s) selected by the user.

Presence server 234 is arranged to provide an indicator that the doorbell has been pressed and present various alternative actions to take to the user (e.g. resident). Optional location service 236 is arranged to determine a location of the user and provide it to doorbell application 232 such that communication with the user can be established. A number of other applications may also be configured, deployed, and shared in application layer 130. The doorbell 202 may be an IMS device with a profile in the IMS HSS component. The initial filter criteria in the IMS HSS may point to the doorbell presence service (doorbell application 232 and presence service 234).

In an operation, notification is forwarded through wireline/wireless network 214 of connectivity and access layer 110 to IMS control and session layer 120. For the IMS session(s), the doorbell may register with P-CSCF 222 and I-CSCF 224. S-CSCF 226 may then initiate the IMS session based communications with doorbell application 232 and presence service 234. The communications may be facilitated through SIP messaging using IMS sessions. Doorbell application 232 determines a location of the user (resident) and notifies presence service 234, which may update presence information on HSS 228. Subsequently, the user is provided with the notification and a list of actions to be selected in response through a client application (watcher client application) on computing device 204.

The user may make selections including, but not limited to, initiating a VoIP conversation with the person at the door, initiating a video conference with the person at the door, obtain a still image or video of the person at the door, provide one of a plurality of “canned” messages to the person at the door, alert a monitoring service and the like. While performing these actions, the user may be in a remote location and access the system through another network such as the Internet.

According to some embodiments, one or more user interfaces (“UIs”) may be provided in computing device 204 and doorbell 202 to enable the user and the person at the door to receive and provide information, such as action selections, alphanumeric entries, and the like.

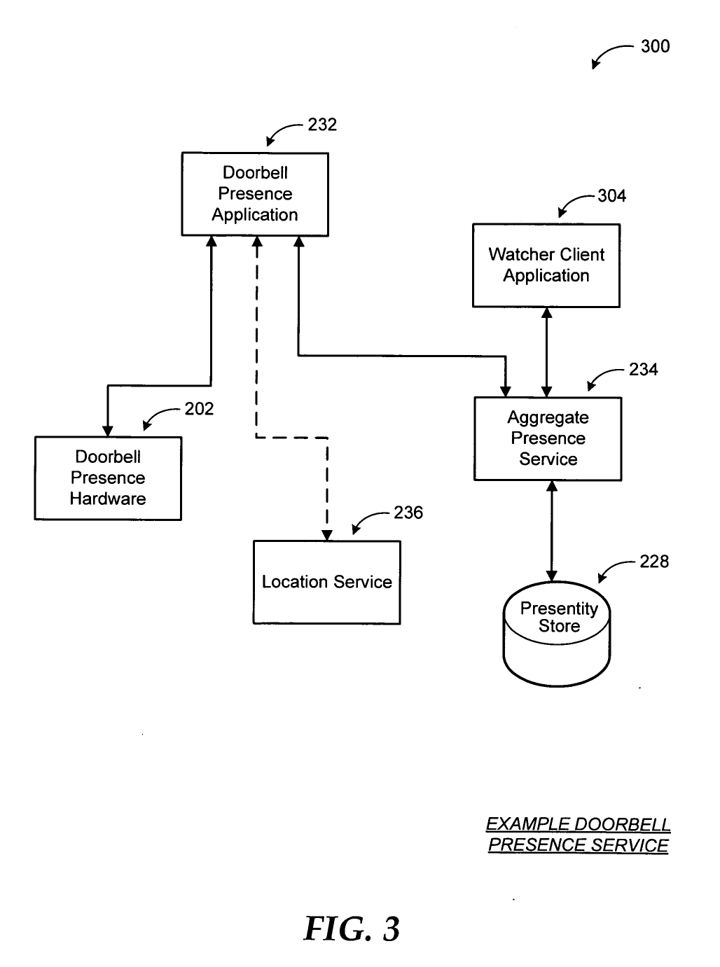

FIG. 3 illustrates a conceptual diagram of components of an example doorbell presence service. The doorbell presence service is a network based service that receives messages from a residence whenever the doorbell is pressed. Diagram 300 summarizes the interactions described in FIG. 2. According to diagram 300, doorbell presence hardware 202 initiates a session by providing a notification to doorbell presence application 232 that someone is at the door. Doorbell presence application 232 may optionally determine a location of the resident using location service 236 and provide aggregate presence service 234 with the user's location and the notification. Aggregate presence service 234 updates a presentity store 228 and enables watcher client application 304 to provide the notification to the user. Watcher client application also provides a list of actions to be selected by the user. Once the user selects and action, aggregate presence service 234 facilitates the execution of tasks associated with the selected action in coordination with doorbell application 232 and any client applications that may be executed on the doorbell presence hardware 202 or computing devices in communication with the doorbell presence hardware 202.

The architecture and scenarios described in FIGS. 1 through 3 are for illustration purposes only and do not constitute a limitation on embodiments. Other configurations of a door entry system with presence service may be implemented without departing from a scope and spirit of the present invention.

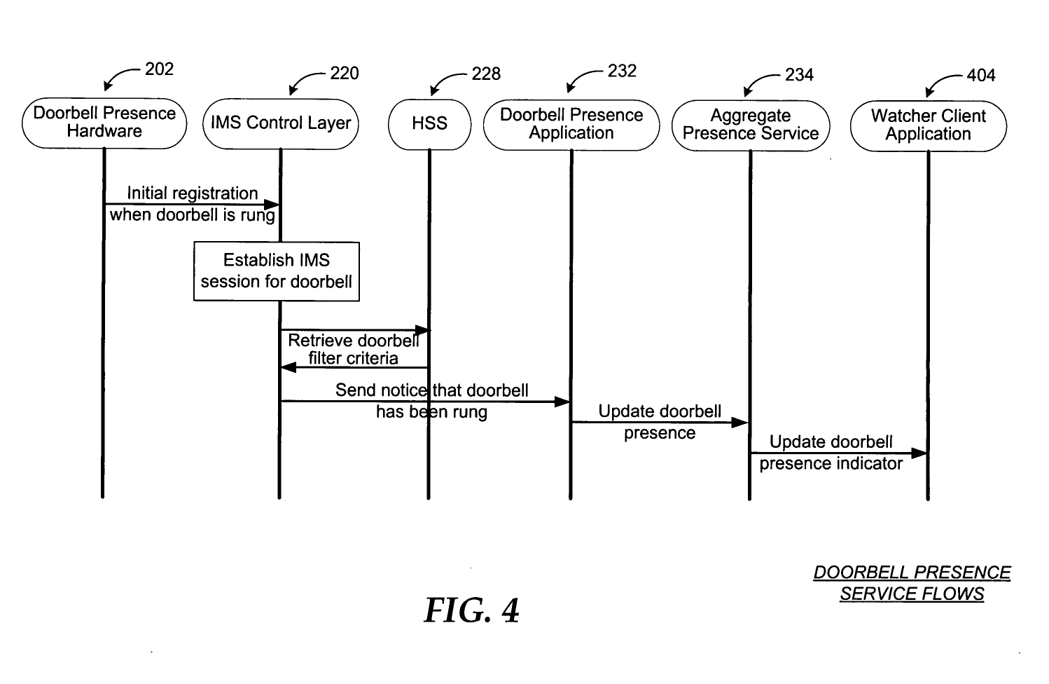

FIG. 4 illustrates action flows in the example doorbell presence service of FIG. 2. The interactions are between components the doorbell presence service described above in detail.

The action flow begins with doorbell presence hardware 102 initiating a registration process with the IMS control layer 220 in response to the doorbell being rung. The IMS control layer establishes a session for the doorbell using SIP messaging and retrieves filter criteria for the doorbell from HSS 228, where a profile for the doorbell is stored.

The IMS control layer 220 then sends notice to doorbell presence application 232 that the doorbell has been rung. Although not shown, doorbell presence application 232 may determine a location of the resident using a location service. Doorbell presence application 232 then updates aggregate presence service 234 with the current location of the resident and the received notice. Aggregate presence service 234, in response, updates a doorbell presence indicator on watcher client application such as an icon, an LED indicator, and the like. Aggregate presence service may also update a presentity store with the information about the resident's current location.

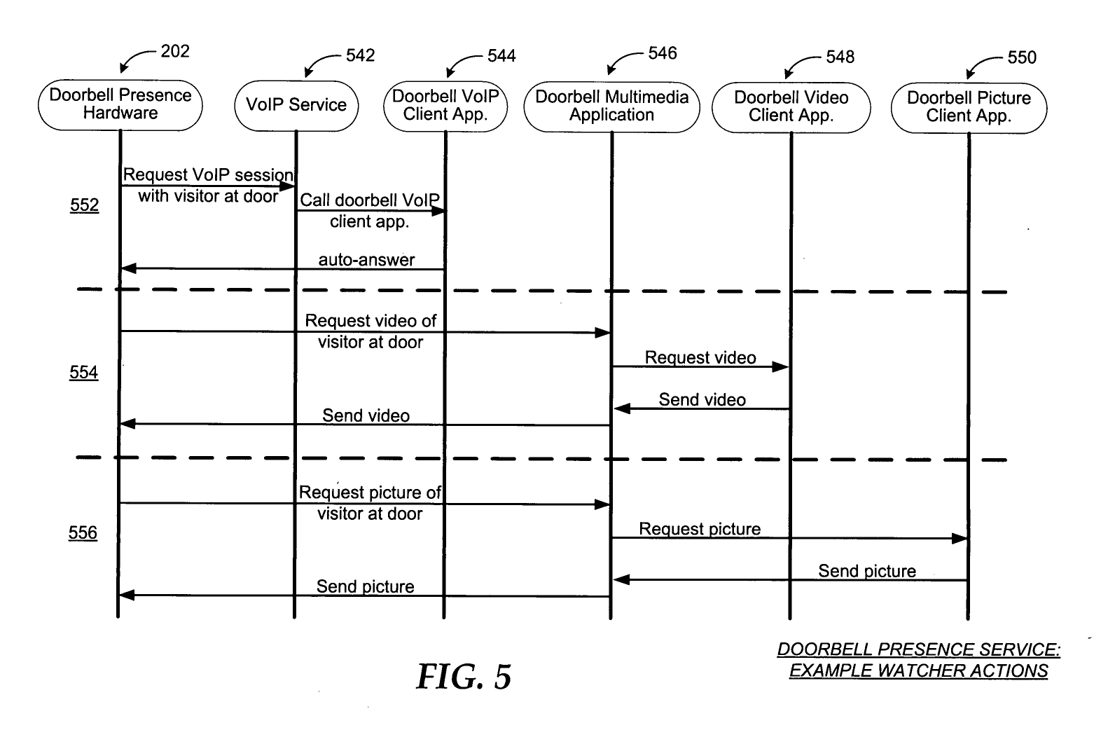

FIG. 5 illustrates action flows in the example doorbell presence service of FIG. 2 based on various watcher selection scenarios. The actions shown in FIG. 5 begin after the resident has received notification about the doorbell being rung and has been presented with a number of actions to select from. As mentioned previously, the actions may include a number of responses depending on capabilities of the system. Three example scenarios and action groups are provided here for illustration purposes.

According to first scenario 552, doorbell presence hardware 202 receives a request for a VoIP call from watcher client application 204 and forwards the request to VoIP service 542, which calls doorbell client VoIP application 544. In response to the call, doorbell client VoIP application 544 may provide an auto-answer establishing the VoIP call between the resident and the visitor at the door.

According to a second scenario 554, doorbell presence service hardware 202 receives from watcher client application 204 a request for a video of the visitor at the door. The request is forwarded to doorbell multimedia application 546, which requests the video from doorbell video client application 548. Doorbell video client application 548 may also reside in doorbell presence hardware or may be executed in a computing device associated with the doorbell presence hardware. In response to the request doorbell video client application 548 begins recording the video and providing it to doorbell multimedia application 546, which in turn forwards the video to watcher client application 204. In other embodiments, a video call may be established using the same or additional components.

According to a third scenario 556, doorbell presence hardware 202 responds to a request for a picture of the visitor at the door from watcher client application 204, and forwards the request to doorbell multimedia application 546, which requests the picture from doorbell picture client application 550. In response to the request, doorbell picture client application 550 may take a still image of the visitor and provide it to doorbell multimedia application 546, which in turn forwards the picture to watcher client application 204. Two or more of the above described scenarios along with others may also be executed simultaneously.

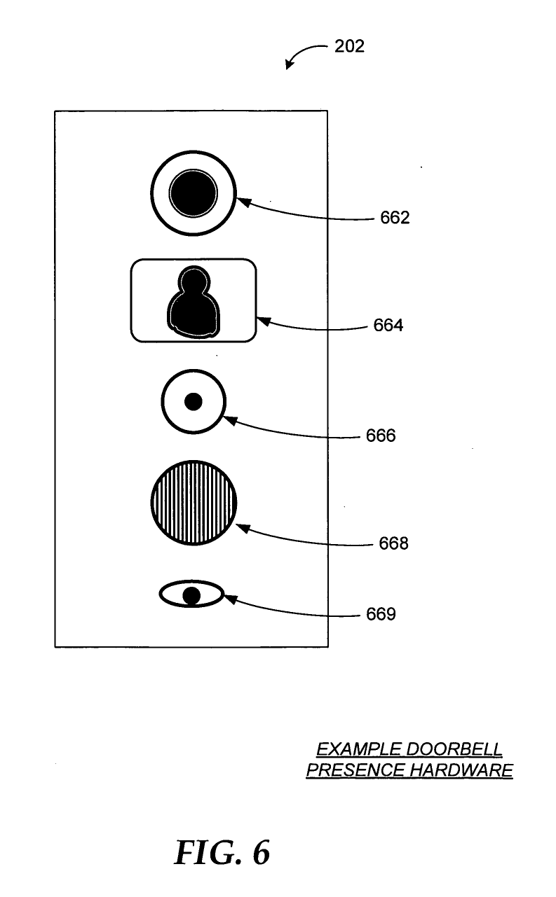

FIG. 6 illustrates an example doorbell presence service hardware according to embodiments. As mentioned previously the doorbell presence service hardware may include a number of integrated components and client applications to facilitate user selected actions in response to the doorbell being pressed.

As examples of physical components, doorbell presence service hardware 202 may include a camera 662 for taking pictures or obtaining a video of the person at the door. A display 664 may be included for establishing a video call between the person at the door and the user (resident). Doorbell button 666 is used to send the initial notification to the doorbell presence system. Speaker 668 and microphone 669 are used to establish a voice call such as a VoIP call between the resident and the person at the door. Speaker 668 may also be used to provide “canned” messages to the person at the door.

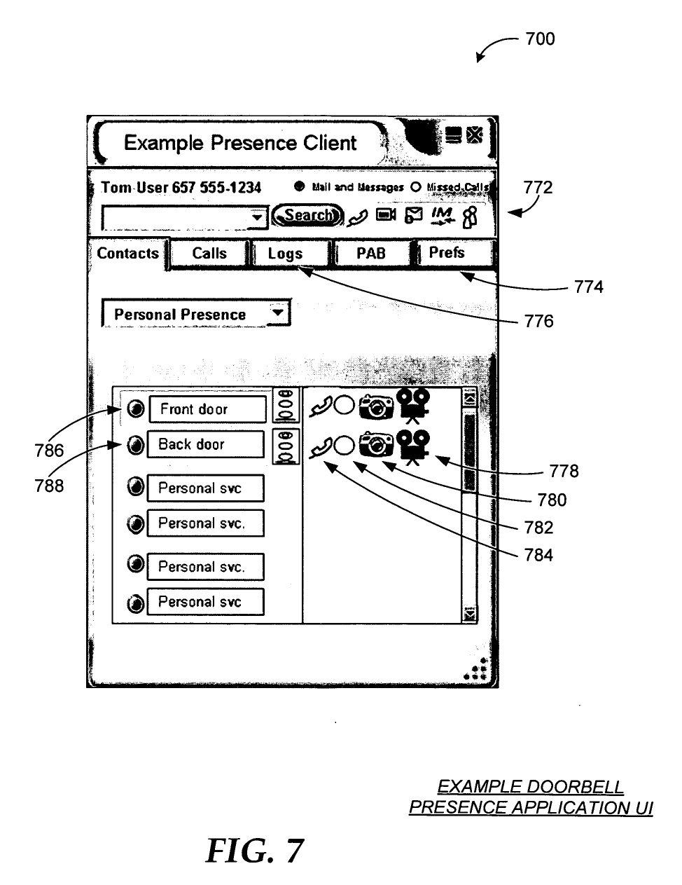

Associated with the above described physical components, one or more client applications may reside on the doorbell presence service hardware 202. Such client applications may include a still image capture application, a video presentation application, a VoIP client application, and the like. To facilitate the client applications and other control tasks associated with the physical components, doorbell presence service hardware 202 may include a processing unit, a memory module, and a data storage device. Such support components may be integrated to the doorbell presence service hardware or be part of a separate computing device that remotely controls the doorbell presence service hardware. Details of example embodiments and configurations of such components have been described in conjunction with FIG. 1. Moreover, doorbell presence service hardware 202 may also support one or more UI's associated with the client applications and the doorbell presence service. An example UI is provided below in conjunction with FIG. 7.

The components and client applications described above are for illustration purposes and do not constitute a limit on embodiments. Other configurations of the doorbell presence service hardware including additional or fewer components may be implemented using the principles described herein. For example, the doorbell presence service hardware may include a keypad for the person at the door to enter a security code for entry to the premises, a motion detector in place of or in addition to the doorbell button, and the like.

FIG. 7 illustrates an example doorbell presence application UI. UI 700 may be part of a watcher client application executed on a user device such as computing device 504. According to some embodiments, the user may be notified and presented with actions to select, as well as the actions executed using the same computing device. In other embodiments, any combinations of the above described events may be presented using separate computing devices.

UI 700 may include additional functionality such as phone service, instant message service, email service, and the like, as shown with icons 752. Different tabs may be provided for various aspects of the UI such as tab 754 (Preferences) for configuration changes, tab 756 (Logs) for recorded information. For a doorbell presence service, the UI may provide different indicators for different entry points such as front door 766 and back door 768. The notification that someone is at the door may be provided by changing a color of the indicator icon to the left of the location designator or the designator itself. Other methods such as flashing the designator, highlighting the designator, and the like, may also be used. Another icon to the right of the location designator indicates the presence of a doorbell presence hardware at the designated location.

Next, a number of icons (758, 760, 762, and 764) next to each location designator show available actions for that location. For example, both the back door 768 an front door 766 are equipped with doorbell presence hardware capable of establishing VoIP call (icon 764), taking picture (icon 760), and obtaining a video of the visitor (icon 758). A watcher client application and its associated UI(s) may of course include fewer or additional functions and present them in other configurations including, but not limited to, drop down menus, panes, separate view screens, and the like.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

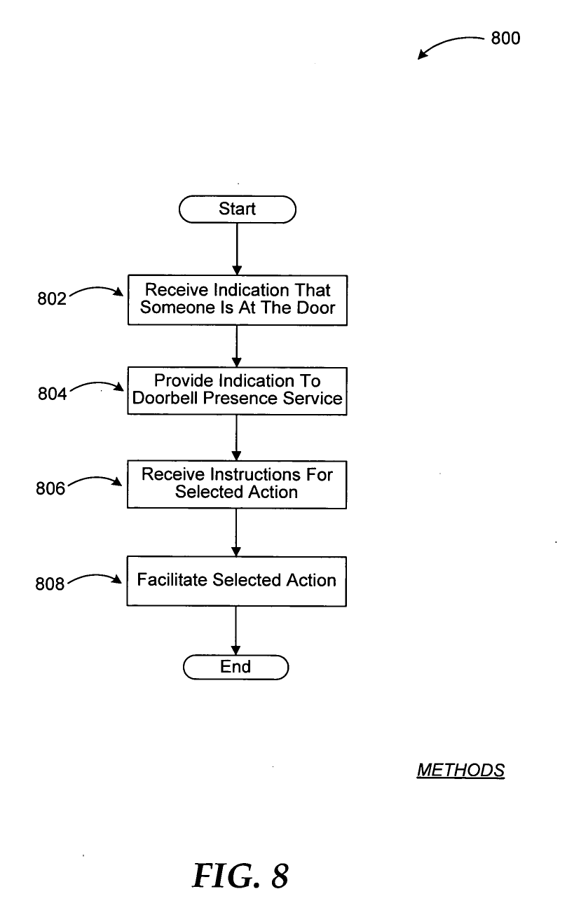

FIG. 8 illustrates a logic flow diagram for a process of providing doorbell presence service according to one embodiment. Process 800 may be implemented in a doorbell presence service.

Process 800 begins with operation 802, where doorbell presence hardware 202 receives an indication that someone is at the door. The indication may include pressing of a button, such as button 666, triggering of a motion detector, or the like. Processing moves from operation 802 to operation 804.

At operation 804, the doorbell presence hardware 202 transmits the indication to the doorbell presence system. The transmission may be through a wireline or wireless network that is part of a connectivity and access layer. In some embodiments, the doorbell presence hardware may include a network communication component that enables it to send the notification directly through the IP network using a SIP session. Processing moves from operation 804 to operation 806.

At operation 806, the doorbell presence hardware receives instructions from the doorbell presence service indicating which client application and associated physical hardware are going to be used in response to the user's selection. For example, the VoIP client application, the microphone, and the speaker may be utilized in establishing a VoIP call in response to the user's selection of the VoIP call. Processing advances from operation 806 to operation 808.

At operation 808, doorbell presence hardware 202 activates the physical components and client applications for the selected action establishing the requested communication or providing the requested image(s). As mentioned previously, doorbell presence hardware 202 may include additional components and client applications associated with other actions including, but not limited to, security actions, entry system controls, and the like. After operation 808, processing moves to a calling process for further actions.

The operations included in process 800 are for illustration purposes. Providing doorbell presence service may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A system for providing a doorbell presence service, comprising:
a doorbell presence hardware acting as a personal presentity configured to:
receive a trigger event;
provide a notification to a presence platform; and
execute an action in response to a selection by the watcher, wherein the selected action is presented to the watcher by the presence platform among a plurality of actions associated with the notification; and
a presentity application configured to:
receive the notification from the doorbell presence hardware;
determine a current location of the watcher;
provide the current location of the watcher to a presence service that is configured to provide the notification along with the plurality of actions to the watcher through a watcher client application and provide the watcher selection to the presentity application; and
provide the watcher selection to the doorbell presence hardware.

2. The system of claim 1, wherein the doorbell presence hardware includes at least one of: a door bell ringing button to receive the trigger event, a speaker, a microphone, and a camera.

3. The system of claim 2, wherein the doorbell presence hardware further comprises a display.

4. The system of claim 2, wherein the doorbell presence hardware further includes a motion detector to receive the trigger event.

5. The system of claim 2, wherein the doorbell presence hardware further includes a keypad for entering a security code.

6. The system of claim 2, wherein the doorbell presence hardware further includes at least one of: a Voice over IP (VoIP) client application to establish a VoIP call, a video client application to establish video communications, and an image acquisition client application to capture an image.

7. The system of claim 6, wherein the client applications reside on a computing device associated with the doorbell presence hardware.

8. The system of claim 2, wherein the doorbell presence hardware further includes a mechanical control client application to control one or more mechanical systems associated with the door.

9. The system of claim 1, wherein the doorbell presence hardware is further configured to execute the selected action by communicating with the presentity application through a Session Initiation Protocol (SIP) session using an IP Multimedia System (IMS) infrastructure.

10. The system of claim 9, wherein the doorbell presence hardware has a registered profile with a home subscriber service (HSS) component of the IMS infrastructure.

11. The system of claim 1, wherein the doorbell presence hardware is further configured to execute an auto-response action in response to one of: a command by the watcher and the watcher not being available.

12. The system of claim 1, wherein the doorbell presence hardware further includes a processing unit, a memory module, and a data storage module.

13. The system of claim 1, wherein the doorbell presence hardware is configured to communicate with the presentity application through one of a wired and wireless network that is part of a connectivity layer of the doorbell presence service.

14. A computer-readable medium having computer executable instructions for providing a doorbell presence service, the instructions comprising:
receiving a trigger event notification from a doorbell presence hardware;
providing the notification to a doorbell presence application;
providing the notification along with a current location of a user to a presence service, wherein the presence service is configured to present the notification and a plurality of actions associated with the notification to the user, and to provide the user's selection to the doorbell presence application; and
providing the user's selection to the doorbell presence hardware such that a client application associated with the selection is activated.

15. The computer-readable medium of claim 14, wherein the instructions further comprise:
providing a response to the user in response to the activation of the client application.

16. The computer-readable medium of claim 15, wherein the client application includes one of: a VoIP call application, a video image acquisition application, a video conference application, a still image acquisition application, and a mechanical control application.

17. The computer-readable medium of claim 15, wherein the response includes one of: establishing a VoIP communication with the user, establishing a video call with the user, providing the user a video of a person at the doorbell presence hardware, and providing the user a still image of the person at the doorbell presence hardware.

18. A system for providing distributed access services using an IMS-based doorbell presence service, comprising:
a means for receiving a trigger event;
a means for providing a notification to a presence platform; and
a means for executing an action in response to a selection by a watcher, wherein the selected action is presented to the watcher by the presence platform among a plurality of actions associated with the notification.

19. The system of claim 18, wherein the means for executing the action includes at least one of:
a means for establishing a VoIP communication with the user;
a means for establishing a video call with the user;
a means for providing the user a video of a person at the doorbell presence hardware;
a means for providing the user a still image of the person at the doorbell presence hardware; and
a means for activating a mechanical control system.

20. The system of claim 18, further comprising:
a means for communicating with the presence platform through one of a wireless means and a wired means.
